(19) United States
(12) Patent Application Publication
(10) Pub. No.: US 2008/0127256 A1
(43) Pub. Date: May 29, 2008

(54) System and method for deploying a virtual dialogue

(76) Inventor: Glenn Hallam, Tallahassee, FL (US)

Correspondence Address: Pennington, Moore, Wilkinson, Bell & Dunbar, P.A., 2nd Floor, 215 S. Monroe Street, Tallahassee, FL, 32301, US

(21) Appl. No.: 11/591,924

(22) Filed: Nov. 2, 2006

(51) Int. Cl. G06F 3/00; G06F 13/00

(52) U.S. Cl. 725/38

(57) ABSTRACT

A system and method for deploying a virtual dialogue between a “virtual person” and an end user. A database is provided for containing a plurality of video segments. Each of the plurality of video segments contains a prerecorded portion of a conversation delivered by the virtual person. A graphical user interface for displaying the plurality of video segments is also provided. The graphical user interface includes a video frame configured to display the video segments there within and an input means for entering the end user's responses to the video segments. Software is used to display the video segments in a sequence based upon the responses entered by the end user.

### BACKGROUND OF THE INVENTION

1. Field of the Invention

This invention relates to the field of web-based marketing and information delivery systems. More specifically the present invention comprises a system and method for deploying a virtual dialogue with a user.

2. Description of the Related Art

Many people including marketers, corporate trainers and politicians seek to develop innovative ways of communicating with individuals about products, services, political messages, and other interests. The Internet has recently provided a new and expansive medium for reaching potential customers, voters, and other individuals. Many of the forms of “advertisement” currently used on the internet are not popular with the end users, however. Unsolicited email advertisements, web-site pop-ups, and advertisement banners are generally considered undesirable. In fact, many end-users utilize filters and other technologies to eliminate or screen out these forms of advertisement.

Individuals will increasingly rely on the internet for news, information, entertainment, and purchasing. Accordingly, conventional advertisement and message delivery systems such as network television and radio are expected to decline. Accordingly, it would be desirable to provide new ways of advertising and delivering messages to interested groups of individuals.

### BRIEF SUMMARY OF THE INVENTION

The present invention comprises a system and method for deploying a virtual dialogue between a “virtual person” and an end user. Because of the interactivity between the end user and the virtual person, the virtual dialogue is believed to be an effective way to communicate with individuals. In addition, the proposed method and system allow the end user to focus the dialogue on issues of interest to the end user. This allows the end user to feel like they are in control of the dialogue and maintains the end user's attention while the virtual person conveys information. As such, the proposed method and system is an effective tool in the field of product and/or service marketing. The proposed invention is also useful in fields where one wishes to convey political or other types of messages to individuals, or in any field where one engages in an interpersonal dialogue with the intent to both convey and collect information.

The present invention accomplishes these and other functions by providing a database containing a plurality of video segments. Each of the plurality of video segments contains a prerecorded portion of a conversation delivered by the virtual person. A graphical user interface for displaying the plurality of video segments is also provided. The graphical user interface includes a video frame configured to display the video segments there within and an input means for entering the end user's responses to the video segments. Software is used to display the video segments in a sequence based upon the responses entered by the end user. As such, the video segments and responses together simulate a natural dialogue between the virtual person and said end user.

### BRIEF DESCRIPTION OF THE SEVERAL VIEWS OF THE DRAWINGS

FIG. 1 is a diagram, illustrating a process for deploying a virtual dialogue.

FIG. 2 is an illustration of a graphical user interface employing the present invention.

FIG. 3 is a diagram, illustrating a database for deploying a virtual dialogue.

### REFERENCE NUMERALS IN THE DRAWINGS

| | | | |
|---|---|---|---|
| 10 | video segment | 12 | yes response option |
| 14 | no response option | 16 | video segment |
| 18 | question text | 20 | yes response option |
| 22 | no response option | 24 | video segment |
| 26 | video segment | 28 | video segment |
| 30 | response option | 32 | response option |
| 34 | video segment | 36 | question text |
| 38 | response option | 40 | response option |
| 42 | response option | 44 | video segment |
| 46 | video segment | 48 | graphical user interface |
| 50 | video frame | 52 | virtual person |
| 54 | user table | 56 | group table |
| 58 | permissions table | 60 | show table |
| 62 | slide table | 64 | rules table |
| 66 | template table | 68 | region table |
| 70 | component table | 72 | answer table |

### DETAILED DESCRIPTION OF THE INVENTION

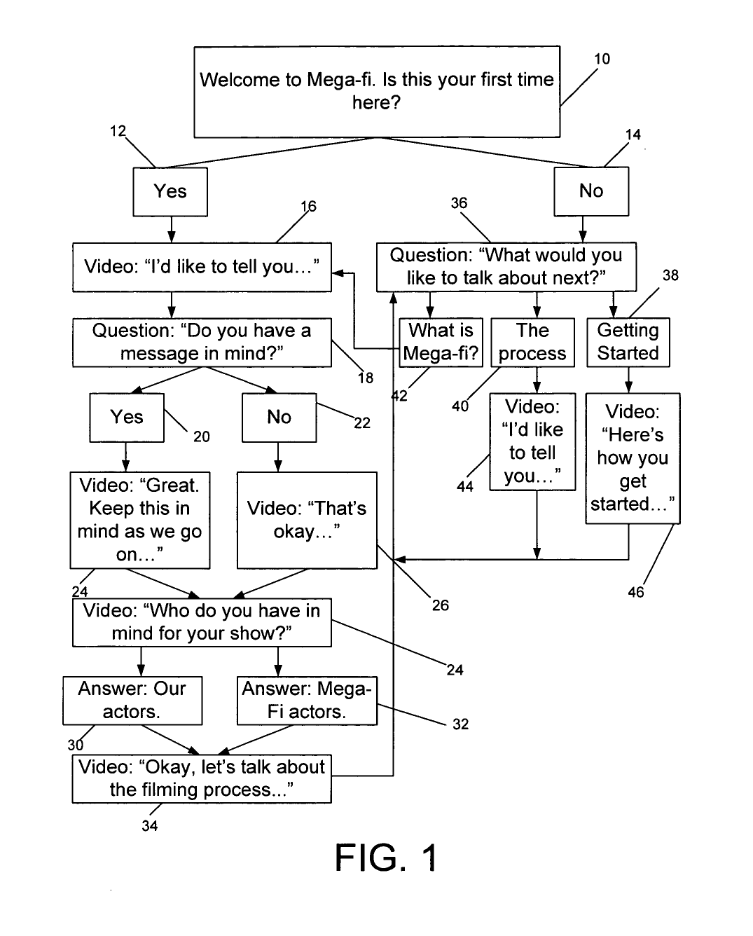

FIG. 1 illustrates a general framework for deploying a virtual dialogue in accordance with the present invention. The example dialogue illustrated in FIG. 1 demonstrates how video segments containing prerecorded portions of a conversation delivered by a first person may be displayed to the user in a sequence based upon the end user's responses to questions. The prerecorded portions of the conversation and the responses, taken together, simulate a natural dialogue between the first person and the end user. Although the virtual dialogue may be deployed over many different media, the reader can envisage the dialogue being deployed over an internet website to a remote end user. It should be apparent to the reader, however, that the virtual dialogue may be deployed with or without being connected to the internet or other computer system.

The virtual dialogue is initiated by video segment 10, which is displayed to the end user. Video segment 10 contains a portion of a prerecorded conversation delivered by a first person. In the current example, the video segment contains the following statement and question delivered by the first person speaker: “Welcome to Mega-fi. Is this your first time here?” The end user is then presented with two response options—yes response option 12 and no response option 14. Yes response option 12 and no response option 14 may be presented to the user as “radio” buttons, hyperlinks, or any other selectable input means for entering the end user's selections.

If the user selects yes response option 12 with the input means, the system displays video segment 16. Video segment 16 contains another portion of the prerecorded conversation delivered by the first person. Video segment 16 contains the speaker's follow-up commentary that introduces the end user to the “Mega-fi” system. For example, the speaker may tell the end user about how the Mega-fi system may be used to effectively communicate a message to another person. Since the end user selected yes response option 12, video segment 16 continues the simulation of natural dialogue by providing information that is appropriate for the response option selected by the end user.

Question text 18 is displayed concurrently with or after video segment 16. Continuing with the present example, the reader is asked “Do you have a message in mind?” Again, the user is presented with two response options—yes response option 20 and no response option 22.

If the user selects yes response option 20, indicating that the user does have a message in mind, the system displays video segment 24. Video segment 24 contains another portion of a prerecorded conversation delivered by the first person. Video segment 24 contains a message which is relevant to the user's selected response. Likewise, if the user selects no response option 22, indicating that the user does not have a message in mind, the system displays video segment 26. Video segment 26 contains a different portion of a prerecorded conversation than that of video segment 24. The portion of the conversation contained in video segment 26 is relevant to no response option 22.

In the present example, the system displays video segment 28 after it finishes displaying video segment 24 or video segment 26. Video segment 28 picks up the conversation where video segment 24 and video segment 26 leaves off, and asks the user “Who do you have in mind for your show?” Video segment 26 may or may not include accompanying text to prompt the user that he or she is being asked a question. The user is presented with two response options—response option 30 or response option 32. The user selects response option 30 if the user plans on using his or her own actors to act as the speaker for the message. The user selects response option 32 is the user would like to hire the third party system's actors.

Once the end user makes his or her selection, the system displays video segment 34. Video segment 34 contains a message delivered by the first person about the filming process. The message contains the appropriate transition language so that the user appears to be having a conversation with a “virtual person.” The dialogue is interactive and reciprocal from the perspective of the end user.

The user is then presented with question text 36. The reader will note that question text 36 is also displayed if the user selects no response option 14 after viewing opening video segment 10. Three response options 38, 40, and 42 are presented along with question text 36. If the user selects response option 42 indicating that they want to know what “Mega-fi” is, video segment 16 is displayed. If the end user selects response option 40, indicating the user would like to talk about “the process,” video segment 48 is displayed. Video segment 48 contains a description of the Mega-fi process delivered by the speaker. If the user selects response option 38, indicating that the user would like to know about how to get started, an appropriate video segment (video segment 46) is displayed. After the system display's video segment 44 or video segment 46, question text 36 is displayed to the user again. Question text 36 may or may not be accompanied with a video segment the second time it is displayed.

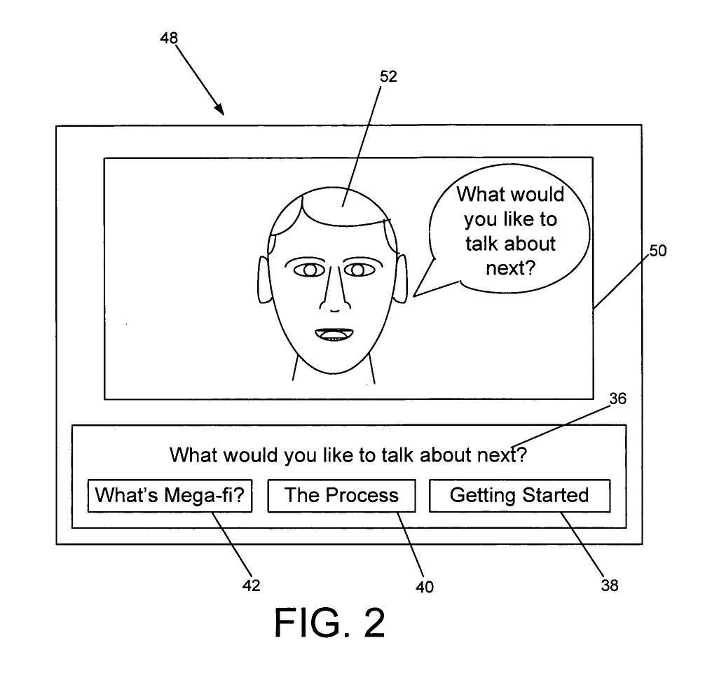

An example of a graphical user interface which may be used to display the video segments, question texts, and response options is illustrated in FIG. 2. Graphical user interface 48 contains video frame 50 within which the various video segments are displayed. Virtual person 52, representing the speaker delivering the dialogue, is viewed delivering the message in video frame 50. Question text 36 is presented beneath video frame 50 along with response options 38, 40, and 42. In the present example, question text 36 is displayed contemporaneously with virtual person 52 asking the same question. The user may enter his or her response to the question by cursoring over the desired response with a mouse or other selection means and pressing the appropriate button. The reader should note that other input means may also be provided for entering responses. Once the user enters the desired selection, a corresponding video segment is displayed in video frame 50.

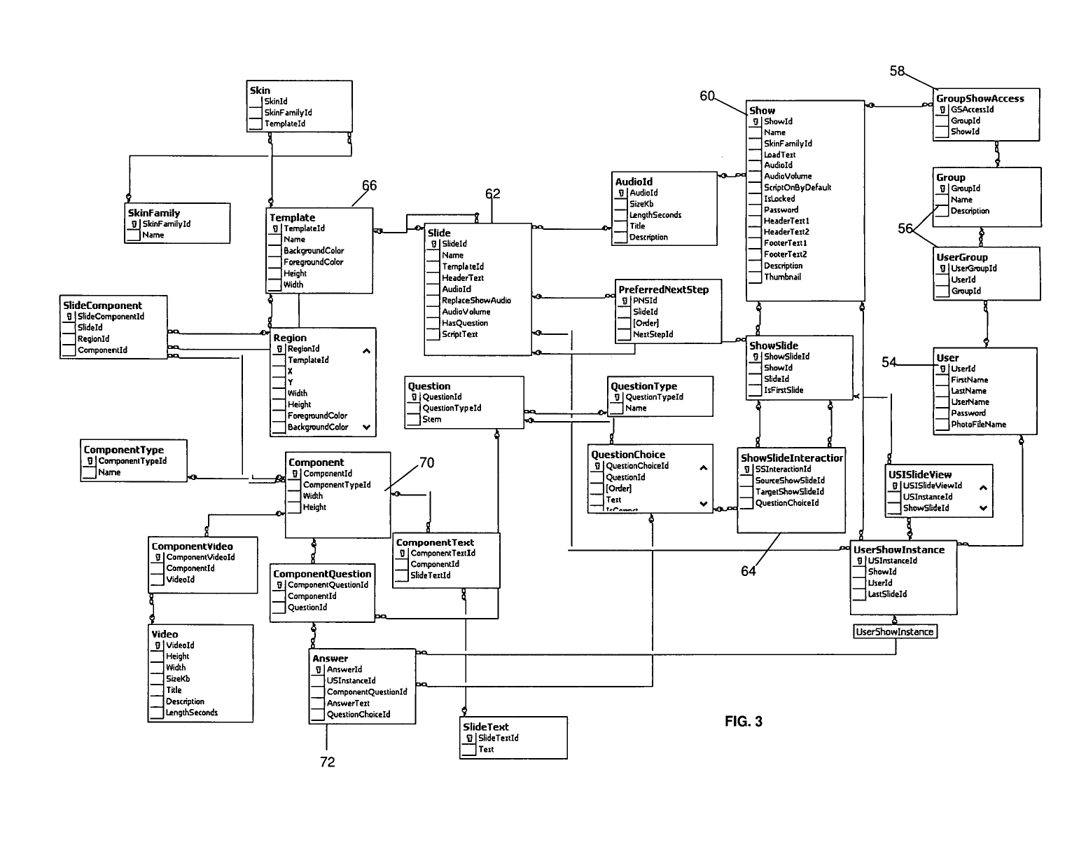

The video segments are preferably contained in a database where appropriate references and associations can be made between the video segments, question texts, and responses. A proposed database for deploying the virtual dialogue is illustrated in FIG. 3. End users of the system are “registered” in user table 54. User table 54 contains conventional information including the users' names and passwords. Each end user is associated with one or more groups. Group tables 56 associate the end user with the appropriate groups by the end user's unique identification number (or “UserId”).

Each group is provided access to different “shows” as defined by access table 58. The term “shows” is used to describe the virtual dialogue that is carried out between the virtual person and the end user. The term “shows” is inclusive of all possible video segments that may be displayed to the end user, and not just the video segments that are actually played during the virtual dialogue. Accordingly, shows contain video segments that may not be displayed to the user if the user does not select a response that would cause the video segment to be displayed.

Each show is associated with a name, a skin (or background look), associated audio files (for background music), a header, a footer, and other information. These references are contained in show table 60. Each show is composed of a collection of slides, which transition to each other according to rules defined in the system. The term “slide” generally describes one of the video segments of the “show.” Information about each slide is provided in slide table 62. Rules table 64 contains the rules governing the interaction of the slides. When a slide is played, the system references rules table 64 to determine which slide and/or question is to be displayed next.

Each slide is also associated with a template. Templates are described in template table 66. Each template is divided into defined “regions.” Each region represents a portion of the graphical user interface. The graphical user interface may be considered a two-dimensional array of regions. Accordingly, each region may be assigned an “x” and “y” coordinate. Each region is associated with various types of “components” including videos, plain text, questions, and response options. These components are referenced to the region in component table 70.

The user's responses to questions are tracked in answer table 72. The system references these answers when applying rules from rule table 64 to determine which slide to display after the current slide. The reader will also note that the responses provided by the end user may be retained for later analysis by the operator of the system or a client using the system to deliver its message through the system. This enables the operator or client to study the audience's reaction to the message.

By now, the reader should understand that the proposed system may contain a large number of shows. Each show may be sponsored by different clients. Accordingly, the proposed system may act as an intermediary for the communication between client's of the system and end user's. As discussed previously, the communication may be transmitted over various media. In the preferred embodiment, a website on the internet provides an access point for end users to participate in the virtual dialogue or shows.

Those that are skilled in the art will know that many existing applications may be used to deploy the proposed virtual dialogue via a website. In the preferred embodiment, the plurality of video segments are contained in an SQL database structure. Macromedia Flash or Adobe Flash (“Flash”) applications may be deployed on the end user's computer and used as the supporting framework for the graphical user interface of the present invention. That is, the end user only need to have a Flash “player” installed on his or her computer to view the shows and participate in the virtual dialogue.

Those that are skilled in the art also know that there are various ways to convert the data illustrated in an SQL database structure into Flash “files” that are read and executed by the end user's Flash player. For example, middleware may be constructed to convert the data contained in the database shown in FIG. 3 into xml commands. This “translation” can occur dynamically utilizing the end user's Flash player to minimize bandwidth requirements.

In order for the virtual dialogue to adequately simulate a natural dialogue it is undesirable to have long wait times between the user's selection of a response and the delivery of the following video segment. Accordingly, in the preferred embodiment a “queue” of slides associated with a show are “preloaded” to the end user's computer before the opening video segment of the dialogue is displayed. By preloading the video segments, the end user does not have to wait for the subsequent video segment to be downloaded to the computer after submitting a response. Instead, the video segment is already prepared for display.

The preceding description contains significant detail regarding the novel aspects of the present invention. It should not be construed, however, as limiting the scope of the invention but rather as providing illustrations of the preferred embodiments of the invention. As an example, response options may also be “open ended” where the user can type or otherwise enter a non-predefined response. Similarly, various input means may be provided for selecting a response option. Such variation does not depart from the scope or purposes of the invention. Thus, the scope of the invention should be fixed by the following claims, rather than by the examples given.

1. A system for deploying a virtual dialogue between a first person and an end user, comprising:
a. a database containing a plurality of video segments, each of said plurality of video segments containing a prerecorded portion of a conversation delivered by said first person;
b. a graphical user interface for displaying said plurality of video segments, said graphical user interface having
i. a video frame configured to display said plurality of video segments there within;
ii. an input means for entering responses of said end user to said plurality of video segments; and
c. software configured to display said plurality of video segments within said video frame in a sequence based upon said responses entered by said end user such that said plurality of video segments and responses together simulate a natural dialogue between said first person and said end user.

2. The system of claim 1, wherein said software is further configured to preload said plurality of video segments before playing one of said plurality of video segments.

3. The system of claim 1, wherein said input means includes a plurality of response options selectable by said end user.

4. The system of claim 3, wherein said plurality of response options includes a first response option and a second response option.

5. The system of claim 4, wherein said plurality of video segments includes an opening video segment, a second video segment, and a third video segment; wherein said software is configured to display said opening video segment before displaying either of said second video segment and said third video segment; wherein said software is configured to display said second video segment after displaying said opening video segment if said end user selects said first response option; and wherein said software is configured to display said third video segment after displaying said opening video segment if said end user selects said second response option.

6. The system of claim 5, wherein said software is further configured to preload said second video segment and said third video segment before playing said opening video segment.

7. A method for deploying a virtual dialogue between a first person and an end user comprising:
a. providing a system for deploying said virtual dialogue between said first person and said end user, said system including
i. a database containing a plurality of video segments, each of said plurality of video segments containing a prerecorded portion of a conversation delivered by said first person;
ii. a graphical user interface for displaying said plurality of video segments, said graphical user interface having
(a) a video frame configured to display said plurality of video segments there within;
(b) an input means for entering responses of said end user to said plurality of video segments; and
iii. software configured to display said plurality of video segments within said video frame in a sequence based upon said responses entered by said end user such that said plurality of video segments and responses together simulate a natural dialogue between said first person and said end user; and
b. displaying an opening video segment in said video frame, said opening video segment selected from said plurality of video segments.

8. The method of claim 7, further comprising the steps of:
a. presenting said end user with a plurality of response options; and
b. allowing said end user to select a selected response option from said plurality of response options after said opening video segment has been displayed.

9. The method of claim 8, further comprising the step of displaying a second video segment in said video frame, said second video segment selected from said plurality of video segments based upon said selected response option.

10. The method of claim 7, further comprising the step of preloading said plurality of video segments before displaying said opening segment.

11. The method of claim 8, wherein said plurality of response options includes a first response option and a second response option.

12. The system of claim 11, wherein said plurality of video segments includes a second video segment, and a third video segment; wherein said software is configured to display said opening video segment before displaying either of said second video segment and said third video segment; wherein said software is configured to display said second video segment after displaying said opening video segment if said end user selects said first response option; and wherein said software is configured to display said third video segment after displaying said opening video segment if said end user selects said second response option.

13. The system of claim 5, wherein said software is further configured to preload said second video segment and said third video segment before playing said opening video segment.

14. A method for deploying a virtual dialogue between a first person and an end user comprising:
a. providing a plurality of video segments, each of said plurality of video segments containing a prerecorded portion of a conversation delivered by said first person;
b. providing a graphical user interface for displaying said plurality of video segments, said graphical user interface having
i. a video frame configured to display said plurality of video segments there within;
ii. an input means for entering responses of said end user to said plurality of video segments; and
c. providing a computer program configured to display said plurality of video segments within said video frame in a sequence based upon said responses entered by said end user such that said plurality of video segments and responses together simulate a natural dialogue between said first person and said end user;
d. displaying an opening video segment in said video frame, said opening video segment selected from said plurality of video segments;
e. presenting said end user with a plurality of response options;
f. allowing said end user to enter a selected response option from said plurality of response options after said opening video segment has been displayed; and
g. displaying a second video segment in said video frame, said second video segment selected from said plurality of video segments based upon said selected response option.
